(19) United States
(12) Patent Application Publication
(10) Pub. No.: US 2021/0011162 A1
(43) Pub. Date: Jan. 14, 2021

(54) Polarization Filtering in LiDAR System

(71) Applicant: Argo AI, LLC, Pittsburgh, PA (US)

(72) Inventors: Gary W. Kamerman, Plainsboro, NJ (US); Christopher John Trowbridge, Dexter, MI (US); Viorel C. Negoita, Plainsboro, NJ (US)

(21) Appl. No.: 16/508,465

(22) Filed: Jul. 11, 2019

(51) Int. Cl. G01S 17/89; G01S 17/10; G01S 17/42; G01S 17/95; G02B 27/28; G01S 7/481

(52) U.S. Cl. CPC G01S 17/89; G01S 17/10; G01S 7/4811; G01S 17/95; G02B 27/28; G01S 17/42

(57) ABSTRACT

A light detection and ranging (LiDAR) system includes a light emitter and a light detector comprising a photodetector. The light detector is configured to receive and detect one or more characteristics of light emitted by the light emitter. The system also includes a polarization filter that is configured to limit polarization of light that is received by the light detector to a single polarization, and thus filter noise and/or certain retroreflected light from reaching the light detector.

### BACKGROUND

Light detecting and ranging (LiDAR) systems are used in various applications. One application for LiDAR systems is autonomous vehicles. Autonomous vehicles may use LiDAR systems to measure the distance from the autonomous vehicle to surrounding objects. To accomplish this task, the LiDAR system illuminates an object with light and measures the light reflected from the object with a sensor. The reflected light is used to determine features of the object that reflected it and to determine the distance the object is from the autonomous vehicle. LiDAR systems also may be used in other applications, such as in aircraft, ships, mapping systems, and others.

The performance of LiDAR systems is frequently limited by noise. A portion of this noise is the result of solar radiation reflected off the target, other artificial light sources reflected off the target, and thermal radiation emitted by the target. This radiation can enter the receiver, be detected by the photosensitive detector within the receiver and produce an electrical signal that interferes with the detection and measurement of the LiDAR signal reflected off the target. Reducing the quantity of emitted thermal radiation and reflected radiation that enters the receiver can result in improved performance.

In addition, all LiDAR systems have a limited range of signal intensities that may be properly detected. There will be a smallest signal that is detectable and a largest signal that is measured properly. Saturation effects that result from large signals may result in incorrect measurement of the signal. The ratio between the smallest and largest signal is commonly referred to as the dynamic range. In LiDAR systems, large signals can result from the illumination of targets which are very close to the LiDAR or by the illumination of retroreflective materials, such as street signs or safety markers, or by both.

This document describes embodiments that are directed to solving the problems described above, and/or other problems.

### SUMMARY

In various embodiments, a light detection and ranging (LiDAR) system includes a light emitter and a light detector comprising a photodetector. The light detector is configured to receive and detect one or more characteristics of light emitted by the light emitter. The system also includes a polarization filter that is configured to limit polarization of light that is received by the light detector to a single polarization, and thus filter noise and/or certain retroreflected light from reaching the light detector.

In some embodiments, the light emitter may include a laser emitter that will emit beams of polarized light, and this emit polarized laser beams.

The system also may include an optical element. The polarization filter may be positioned in front of the optical element so that during operation, reflected light entering the LiDAR system will pass through the polarization filter before reaching the optical element. Alternatively, the polarization filter may be positioned between the optical element and the light detector so that during operation, light entering the LiDAR system will pass through the optical elements before reaching the polarization filter, and through the polarization filter before reaching the light detector. If the system includes multiple optical elements, the polarization filter may be positioned between the optical elements so that during operation, light entering the LiDAR system will pass through at least one of the optical elements before reaching the polarization filter, and through the polarization filter before reaching at least one other one of the optical elements. In each embodiment, the polarization filter will filter out any light that does not exhibit a particular polarization, such as a vertical polarization or a horizontal polarization.

In some embodiments, the polarization filter may be combined with a quarter wave plate to filter out any light that does not exhibit a polarization that corresponds to a polarization of light emitted by the light emitter.

This document also discloses a method of operating a LiDAR system, in which the LiDAR system includes a light emitter, a light detector and a polarization filter. The method includes causing the light emitter to emit beams of polarized light, each of which exhibits a vertical polarization or a horizontal polarization. The system will receive reflected beams of polarized light, wherein the reflected beams correspond to the beams emitted by the light emitter. The system will limit the reflected beams that reach the light detector to those reflected beams that have a single polarization by passing the reflected beams through a polarization filter before the reflected beams reach the light detector. When the reflected beams pass through the polarization filter, the system may prevents noise light and/or retroreflected light from cube corner reflectors from reaching the light detector.

### BRIEF DESCRIPTION OF THE DRAWINGS

FIG. 1 illustrates an example LiDAR receiver with polarization filter.

FIG. 2 illustrates how the receiver of FIG. 1 may filter noise light from light that is reflected from an object that the LiDAR receiver will detect.

FIG. 3 illustrates how light may be mixed and focused on a detector.

FIG. 4 illustrates an example LiDAR technique that employs polarization.

FIG. 5 illustrates example elements of a LiDAR system.

FIGS. 6A-6C illustrate various example configurations of a polarization filter in a LiDAR system.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

As used in this document, the term “light” means electromagnetic radiation associated with optical frequencies, e.g., ultraviolet, visible, infrared and terahertz radiation. Example emitters of light include laser emitters. In this document, the term “emitter” will be used to refer to an emitter of light, such as a laser emitter that emits infrared light.

In this document, when terms such “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The present disclosure generally relates to a LiDAR system such as may be used in connection with an autonomous vehicle or other robotic system. References to various embodiments and examples set forth in this specification do not limit the scope of the disclosure and merely set forth some of the many possible embodiments of the appended claims.

LiDAR receivers include a photosensitive component that generates an electrical signal in response to the light which impinges upon it. As a result, the performance of all LiDAR receivers is limited by the amount of signal light which reaches the photosensitive components and the amount of light from other sources which reaches the photosensitive components. Light from other sources is commonly referred to as noise. The ratio of the intensity of the signal light to the intensity of the noise light is commonly referred to as the signal-to-noise ratio (SNR). In general, and in the absence of saturation effects, the performance of a LiDAR receiver increases as the SNR increases and decreases as the SNR decreases. The SNR may be increased by increasing the intensity of the signal, decreasing the intensity of the noise, or both.

In the past, some polarization sensitive LiDAR systems have attempted to exploit the depolarization characteristics of the reflecting materials in order to extract information about the material (e.g., is a naturally occurring material or is it man-made). These attempts were a result of the realization that man-made materials are smoother and tend to depolarize retroreflected light less than rougher, naturally occurring materials. These previous, polarization sensitive LiDAR systems have not attempted to use polarization filtering to enhance the SNR of the receiver.

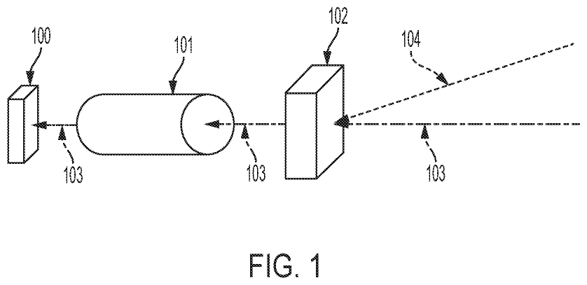

Referring to FIG. 1, to reduce the noise and increase the SNR of a LiDAR system, a light emitter (not shown, but which originates a beam from the right side of the image) of a LIDAR system is configured to transmit only polarized light. All light is composed of a mixture of up to four polarization states: vertical, horizontal, right handed circular and left handed circular. Accordingly, to limit the polarization of light that the receiver will receive, a polarization filter 102 may be positioned in front of the LiDAR receiver so that only the transmitted polarization is detected by the receiver.

The receiver includes one or more photosensitive detectors 100 that produce an electrical signal when light 103 is absorbed by the detector(s). The receiver may also include one or more optical elements 101 such as a lens, reflector, mirror, window, or spectral filter. When the receiver includes optical elements in addition to the photosensitive detector, the polarization filter 102 may be placed after the optical element(s) 101 but in front of the photosensitive detector(s) 100. When the receiver includes more than one optical element 101 in addition to the photosensitive detector 100, the linear polarization filter may be placed between the optical elements but in front of the photosensitive detector 100.

The filter 102 may be oriented so that the amount of reflected LiDAR signal that reaches the detector is increased or maximized. Light from noise sources 104 and/or retroreflective markers may also impinge upon the polarization filter 102. These sources will not, in general, have a polarization aligned to that of the polarization filter. That portion of the noise 104 that is not aligned with the polarization filter will be blocked by the polarization filter 102 and will not reach the photosensitive components 100. This reduces the intensity of the noise reaching the photosensitive components 100, thus increasing the SNR and improving the receiver performance.

Retroreflectors such as safety markers, bicycle reflectors and certain street sign materials are based upon embedded cube corners (i.e., pyramid-like structures). In addition to producing a very strong reflection, cube corner reflectors also rotate the polarization of the reflected light. As a result, much of the light reflected by these materials also may be blocked by the polarization filter 102. This improves the effective dynamic range of the LiDAR.

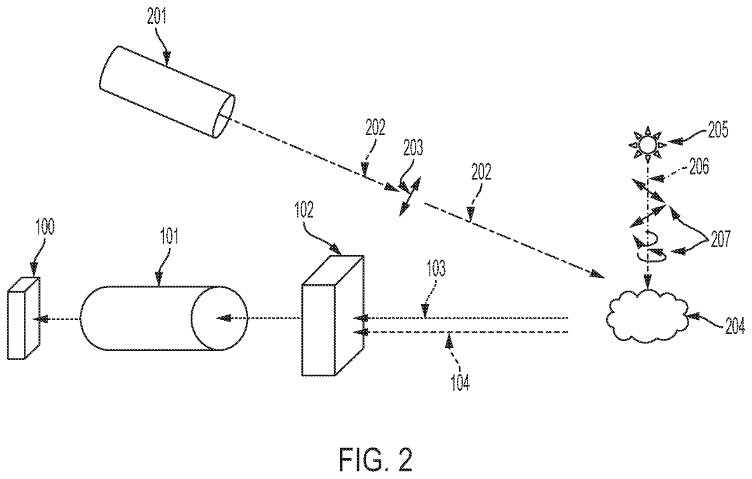

In the embodiment shown in FIG. 2, light 202 is generated by a light-emitting device 201 such as a laser. The generated light may be linearly polarized in the vertical direction 203. The light is directed to an object 204 that is also illuminated by light 206 originating from noise light sources 205 such as the sun, street lights, vehicle headlights, etc. This noise illumination 206 may be unpolarized, or may have any polarization 207 or any combination of polarizations. In the specific case of the sun, the illumination 206 is unpolarized. Unpolarized light may be regarded as containing equal quantities of vertically and horizontally polarized light having a random phase relationship between them. A portion of the light 103 that is reflected off the object 204 will propagate toward the LiDAR receiver 100, passing through a linear polarization filter 102, preferably oriented with the polarization axis vertical. A portion of the noise illumination 104 will also reflected off the object 204 and will propagate toward the LiDAR receiver 100. However, upon reaching the linear polarization filter 102, only that portion of the reflected noise illumination 104 having a matching vertical polarization will pass through the filter 102 and reach the photosensitive element 100. The remainder of the noise illumination will be blocked by the polarization filter 102.

The reflected light 103 now having passed through the polarizing filter 102 will be accompanied by less of the noise light 104. This reduces the total noise arriving at the photosensitive detector 100, resulting in increased SNR and improved performance.

In alternative embodiments, the polarization filter 102 may be oriented other than in a vertical position. The generated light 202 may have its polarization oriented to correspond to the orientation of the polarization filter. In still other embodiments, the generated light 202 may have other polarization states such as circular. In such cases, the polarization filter 102 may be combined with other optical polarization manipulation elements, such as a quarter-wave plate (QWP). In some embodiments, the polarization filter 102 either individually or in combination with other polarization manipulation elements may be positioned in front of or behind the optical elements 101, or when the optical elements contain a plurality of components, within the optical elements 101.

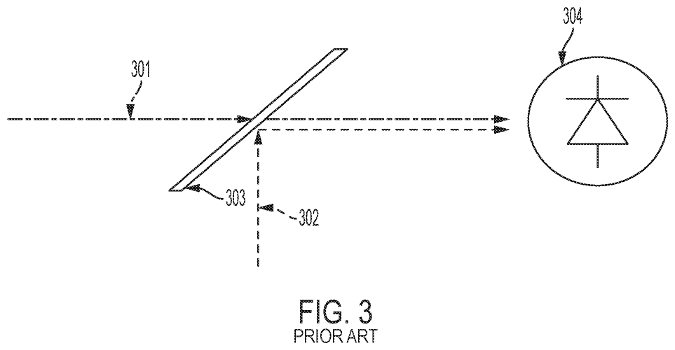

Referring to FIG. 3, in heterodyne systems, the received light 301 is mixed with a local oscillator and the combination is focused onto a photosensitive detector. The received light 301 and an internal local oscillator 302 are mixed so that they interfere spatially and temporally so as to create a beat frequency at the frequency difference between the local oscillator and the received signal. The mixing is often facilitated by passing the received light 301 through a transparent optical element 303 and having the local oscillator 302 reflect off one surface of the transparent optical element. Frequently, most of the local oscillator also passes through the transparent optical element but a small portion is reflected and propagates with the received signal to a photosensitive element 304. This beat frequency is observable to the photosensitive element 304. If the local oscillator frequency is known, then the frequency and phase of the receive signal may be determined. This, for example, permits the determination of any frequency change in the reflected signal with respect to the transmitted signal. Such frequency changes may arise from the transmitter of the target being in motion by the Doppler shift. The optical mixing process requires that the polarization of the local oscillator and the received signal match. As a result, all coherent LiDAR systems of the prior art are polarization sensitive, even though a polarization filter is not used to block cross polarized radiation as described in the present invention.

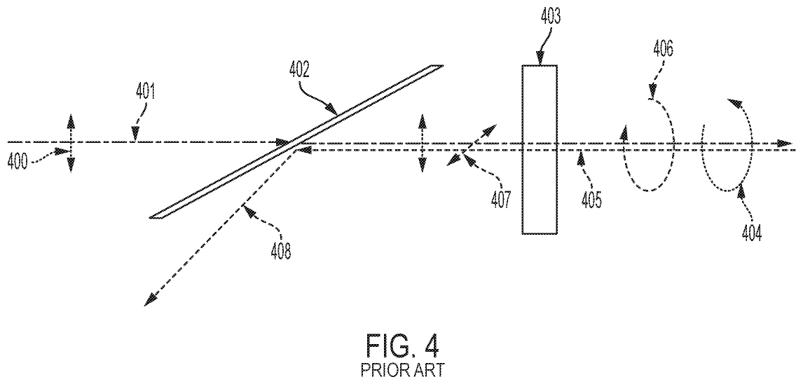

An example of a prior art LiDAR technique that employs polarization to perform transmit to receive isolation is shown in FIG. 4. Linearly polarized 400 light 401 first passes through a polarization beam splitter (PBS) 402 such as a Brewster's Angle Polarizer or a wire grid polarizer or any other type of polarization beam splitter. The linearly polarized light then passes through a quarter wave plate (QWP) 403. The QWP is oriented such that the QWP converts the linearly polarized light into circularly polarized light 404. Circularly polarized light may rotate clockwise (right handed circular or RHC), or it may rotate counterclockwise (left handed circular or LHC). The circularly polarized light then travels to the target where it is reflected. Upon reflection, the sense of rotation is preserved but the direction of propagation is reversed so that RHC is converted into LHC and vice versa. Light 405 with the opposite circular polarization 406 then propagates back to the lidar and passes through the QWP 403 a second time where the QWP converts the circularly polarized light into linearly polarized light. However, since the sense of rotation is now reversed the linear polarization state of the retroreflected light will be orthogonal to the original polarization that passed through the PBS 402. The orthogonal polarization state is then reflected by the PBS into the receiver path 408. This process then isolates the transmitter from the receiver and the receiver actually only receives one polarization state. The purpose of this technique is not to reject cross polarized noise or minimize saturating signal but to allow operation of the transmitter and receiver through a single aperture with no parallax.

All other known LiDARs do not use polarization blocking filters. Consequently, these devices receive more noise and have lower SNR for a given amount of signal. The method described in FIGS. 1 and 2 above helps resolve this issue.

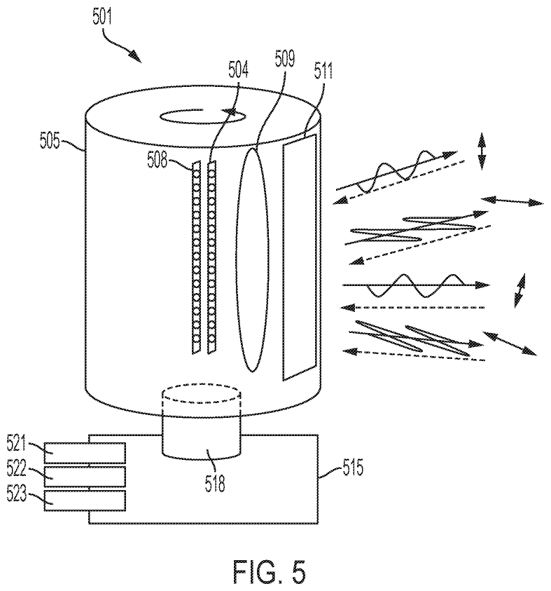

FIG. 5 shows an example LiDAR system 501 as may be used in various embodiments. The LiDAR system 501 includes a housing 505 that may be rotatable 360° about a central axis such as hub or axle 518. The housing may include an emitter/receiver aperture 511 made of a material transparent to light, so that the system can emit light through the aperture 511 and receive reflected light back toward the aperture 511 as the housing 505 rotates around the internal components. In an alternative embodiment, the outer shell of housing 505 may be a stationary dome, at least partially made of a material that is transparent to light, with rotatable components inside of the housing 505.

Inside the rotating shell or stationary dome is a light emitter 504 that is configured and positioned to generate and emit pulses of light through the aperture 511 or through the transparent dome of the housing 505 via one or more laser emitter chips or other light emitting devices. The emitter 504 may include any number of individual emitters, including for example 8 emitters, 64 emitters or 128 emitters. The individual beams emitted by emitter 504 will have a well-defined state of polarization that may or may not be the same across the entire array. As an example, some beams may have vertical polarization and other beams may have horizontal polarization. Other states of polarization such as left hand circular right hand circular polarization are also possible.

The LiDAR system will also include a light detector 508 containing a photodetector or array of photodetectors positioned and configured to receive light reflected back into the system. The emitter 504 and detector 508 would rotate with the rotating shell, or they would rotate inside the stationary dome of the housing 505. One or more optical element structures 509 may be positioned in front of the light emitter 504 and/or the detector 508 to serve as one or more lenses or waveplates that focus and direct light that is passed through the optical element structure 509.

The optical element structures 509, aperture 511, detector 508 and/or any components between these structures may incorporate one or more polarization filters to filter light of other than a particular polarization before the light reaches the detector as described above in FIG. 1 (element 102).

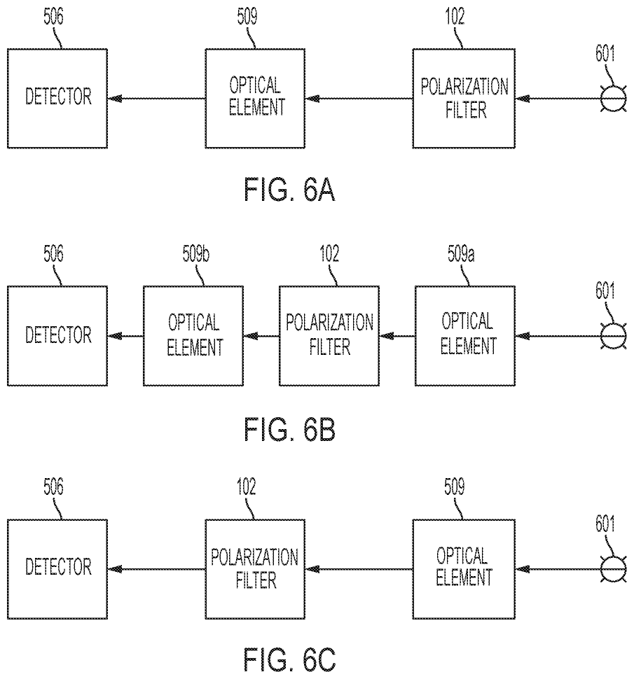

For example, referring to FIG. 6A, one or more polarization filters 102 may be positioned in front of (i.e., on or outside of a receiving surface of) the optical element 509 so that reflected light 601 entering the LiDAR system will pass through the polarization filter 102 before reaching the optical element 509. Only non-filtered beams will reach the optical element 509 and pass to the light detector 504.

If the LiDAR system includes multiple optical elements, then as shown in FIG. 6B the polarization filter 102 may be positioned between any pair of the optical elements 509a, 509b so that during operation, light 601 entering the LiDAR system will pass through at least one of the optical elements 509a before reaching the polarization filter 102. Beams not filtered out by the polarization filter 102 will pass through the polarization filter 102 and reach at least one other one of the optical elements 509b, and then the light detector 504.

As another alternative, as illustrated in FIG. 6C, the LiDAR system may include one or more optical elements 509, and the polarization filter 102 may be positioned after the optical elements 509, and between the final (innermost) optical element and the light detector 506, so that light 601 entering the LiDAR system will pass through all of the optical elements 601 before reaching the polarization filter 102, Beams not filtered out by the polarization filter 102 will pass through the polarization filter 102 before reaching the light detector 506.

Returning to FIG. 5, the LiDAR system will include a power unit 521 to power the light emitter unit 504, a motor 523 that can turn the axle 518, the housing 505 or other components, and electronic components. The LiDAR system will also include an analyzer 515 with elements such as a processor and non-transitory computer-readable memory (collectively, 522) containing programming instructions that are configured to enable the system to receive data collected by the light detector unit, analyze it to measure characteristics of the light received, and generate information that a connected system can use to make decisions about operating in an environment from which the data was collected. Optionally, the analyzer 515 may be integral with the LiDAR system 501 as shown, or some or all of it may be external to the LiDAR system and communicatively connected to the LiDAR system via a wired or wireless communication network or link. For example, the motor 523 may be integral with the LiDAR system, but the processor and/or memory 522 may be remote from the other components.

The features and functions described above, as well as alternatives, may be combined into many other different systems or applications. Various alternatives, modifications, variations or improvements may be made by those skilled in the art, each of which is also intended to be encompassed by the disclosed embodiments.

1. A light detection and ranging (LiDAR) system, comprising:
a light emitter; and
a light detector comprising a photodetector, wherein the light detector is configured to receive and detect one or more characteristics of light emitted by the light emitter; and
a polarization filter, wherein the polarization filter is configured to limit polarization of light entering the light detector to a single polarization and thus filter noise light from reaching the light detector.

2. The LiDAR system of claim 1, wherein the light emitter comprises a laser emitter that is configured to emit a plurality of beams of polarized light, each of which will comprise a polarized laser beam.

3. The LiDAR system of claim 1, further comprising an optical element, and wherein the polarization filter is positioned in front of the optical element so that during operation, reflected light entering the LiDAR system will pass through the polarization filter before reaching the optical element.

4. The LiDAR system of claim 1, further comprising a plurality of optical elements, and wherein the polarization filter is positioned between the optical elements so that during operation, light entering the LiDAR system will pass through at least one of the optical elements before reaching the polarization filter, and through the polarization filter before reaching at least one other one of the optical elements.

5. The LiDAR system of claim 1, wherein the polarization filter is configured to filter out any light that does not exhibit a vertical polarization.

6. The LiDAR system of claim 1, wherein the polarization filter is combined with a quarter wave plate and is configured to filter out any light that does not exhibit a polarization that corresponds to a polarization of light emitted by the light emitter.

7. The LiDAR system of claim 1, further comprising or more optical elements, and wherein the polarization filter is between the optical elements and the light detector so that during operation, light entering the LiDAR system will pass through all of the optical elements before reaching the polarization filter, and through the polarization filter before reaching the light detector.

8. A light detection and ranging (LiDAR) system, comprising:
a light emitter; and
a light detector comprising a photodetector, wherein the light detector is configured to receive and detect one or more characteristics of light emitted by the light emitter; and
a polarization filter, wherein the polarization filter is configured to limit polarization of light entering the LiDAR system to a single polarization and thus filter retroreflected light from cube corner reflectors and prevent it from reaching the light detector.

9. The LiDAR system of claim 8, wherein the light emitter comprises a laser emitter that is configured to emit a plurality of beams of polarized light, each of which will comprise a polarized laser beam.

10. The LiDAR system of claim 8, further comprising an optical element, and wherein the polarization filter is positioned in front of the optical element so that, during operation, light entering the LiDAR system will pass through the polarization filter before reaching the optical element.

11. The LiDAR system of claim 8, further comprising a plurality of optical elements, and wherein the polarization filter is positioned between the optical elements so that light entering the LiDAR system will pass through at least one of the optical elements before reaching the polarization filter, and through the polarization filter before reaching at least one other of the optical elements.

12. The LiDAR system of claim 8, wherein the polarization filter is configured to filter out any light that does not exhibit a vertical polarization.

13. The LiDAR system of claim 8, wherein the polarization filter is combined with a quarter wave plate and is configured to filter out any light that does not exhibit a polarization that corresponds to a polarization of light emitted by the light emitter.

14. The LiDAR system of claim 8, further comprising a plurality of optical elements, and wherein the polarization filter is positioned between the optical elements and the light detector so that during operation, light entering the LiDAR system will pass through at all of the optical elements before reaching the polarization filter, and through the polarization filter before reaching the light detector.

15. A method of operating a LiDAR system, the method comprising:
by a LiDAR system comprising a light emitter, a light detector, and a polarization filter:
causing the light emitter to emit a plurality of beams of polarized light, wherein each of the beams exhibits a vertical polarization or a horizontal polarization;
receiving reflected beams of polarized light, wherein the reflected beams comprise beams that correspond to the beams emitted by the light emitter; and
limiting the reflected beams that reach the light detector to those reflected beams that have a single polarization by passing the reflected beams through a polarization filter before the reflected beams reach the light detector.

16. The method of claim 15, wherein passing the reflected beams through the polarization filter prevents noise light from reaching the light detector.

17. The method of claim 15, wherein passing the reflected beams through the polarization filter prevents retroreflected light from cube corner reflectors from reaching the light detector.

18. The method of claim 15, wherein the LiDAR system further comprises an optical element positioned between the light detector and the polarization filter, and receiving the reflected beams of polarized light comprises:
passing each of the reflected beams through the polarization filter; and
then passing non-filtered beams through the optical element to the light detector.

19. The method of claim 15, wherein the LiDAR system further comprises an optical element, the polarization filter is positioned between the light detector and the optical element, and receiving the reflected beams of polarized light comprises:
passing each of the reflected beams through the optical element;
then passing the reflected beams to the polarization filter; and
then passing beams not filtered by the polarization filter to the light detector.

20. The method of claim 15, wherein the LiDAR system further comprises a plurality of optical element, the polarization filter is positioned between at least two of the optical elements, and receiving the reflected beams of polarized light comprises:
passing each of the reflected beams through a first optical element;
then passing the reflected beams to the polarization filter; and
then passing beams not filtered by the polarization filter through at least one additional optical element and to the light detector.
